(19) United States
(12) Patent Application Publication
(10) Pub. No.: US 2026/0118604 A1
(43) Pub. Date: Apr. 30, 2026

(54) CONNECTOR COMPONENT

(71) Applicant: SUMITOMO ELECTRIC INDUSTRIES, LTD., Osaka (JP)

(72) Inventors: Tsutaru KUMAGAI, Osaka (JP); Tetsuya NAKANISHI, Osaka (JP)

(73) Assignee: SUMITOMO ELECTRIC INDUSTRIES, LTD., Osaka (JP)

(21) Appl. No.: 19/360,682

(22) Filed: Oct. 16, 2025

(30) Foreign Application Priority Data
Oct. 25, 2024 (JP) 2024-188111

(51) Int. Cl. G02B 6/42

(52) U.S. Cl. CPC G02B 6/4231; G02B 6/4214

(57) ABSTRACT

A connector component according to an embodiment includes a substrate component fixed to an optical IC substrate configured to allow light to be incident on and emitted from a substrate surface in a direction intersecting the substrate surface, and an optical component configured to be attached to and detached from the substrate component and optically coupled with the light when attached to the substrate component. One of the substrate component and the optical component has a guiding pin configured to fix a position of the optical component with respect to the substrate component. One of the substrate component and the optical component not having the guiding pin has a guiding hole into which the guiding pin is inserted. The guiding hole is opened in a direction intersecting a direction in which the guiding pin is inserted into the guiding hole.

### CROSS REFERENCE TO RELATED APPLICATIONS

This application claims priority based on Japanese Patent Application No. 2024-188111 filed on October 25, 2024, and the entire contents of the Japanese patent application are incorporated herein by reference.

### TECHNICAL FIELD

The present disclosure relates to a connector component.

### BACKGROUND

Patent literature 1 (U.S. Patent Application Publication No. 2017/0003456) describes a connection structure of a ferrule holding an optical fiber and an optical component. The ferrule has two guiding pins for positioning with respect to the optical component. The optical component has two guiding holes into which the two guiding pins are inserted, respectively. The guiding hole is circular.

Patent literature 2 (Japanese Unexamined Patent Application Publication (Translation of PCT Application) No. 2017-501439) describes an optical transceiver. The optical transceiver includes a base plate and a housing mounted on the base plate. The housing includes an optical fiber block for fixing an optical fiber and a lens. The base plate has an alignment plate with two round reference holes and an optical element. Light from the optical fiber is reflected by the lens toward the base plate and coupled to the optical element. The housing has two pins inserted into the two reference holes.

### SUMMARY

A connector component according to the present disclosure includes a substrate component fixed to an optical IC substrate configured to allow light to be incident on and emitted from a substrate surface in a direction intersecting the substrate surface, and an optical component configured to be attached to and detached from the substrate component and optically coupled with the light when attached to the substrate component.

One of the substrate component and the optical component has a guiding pin configured to fix a position of the optical component with respect to the substrate component. One of the substrate component and the optical component not having the guiding pin has a guiding hole into which the guiding pin is inserted. The guiding hole is opened in a direction intersecting a direction in which the guiding pin is inserted into the guiding hole.

### BRIEF DESCRIPTION OF THE DRAWINGS

FIG. 1 is a perspective view showing a connector component according to an embodiment.

FIG. 2 is a plan view showing the connector component according to the embodiment.

FIG. 3 is a side view showing the connector component according to the embodiment.

FIG. 4 is a perspective view showing an optical component of the connector component according to the embodiment.

FIG. 5 is a perspective view showing a substrate component and an optical IC substrate of the connector component according to the embodiment.

FIG. 6 is a cross-sectional view showing the substrate component and a guiding pin of FIG. 5.

FIG. 7 is a diagram showing the guiding pin, a guiding hole, and a coating layer of FIG. 6.

### DETAILED DESCRIPTION

Incidentally, in optical connection, since repetitive reproducibility in several micrometers may be required, even a foreign substance having a size of several micrometers may need to be removed. However, in a case where a guiding hole into which a guiding pin for positioning is inserted has a circular shape, when the foreign substance enters the guiding hole, it may be difficult to remove the foreign substance. The flux residue, which is a kind of foreign substance, may cause an operation failure or a contact failure. Thus, it is required to remove the foreign substance more reliably and easily.

The present disclosure is directed to providing a connector component that can more reliably and easily remove a foreign substance.

### Description of Embodiment of the Present Disclosure

First, embodiments of the connector component according to the present disclosure will be listed and described. (1) A connector component according to the embodiment includes a substrate component fixed to an optical IC substrate configured to allow light to be incident on and emitted from a substrate surface in a direction intersecting the substrate surface, and an optical component configured to be attached to and detached from the substrate component and optically coupled with the light when attached to the substrate component. One of the substrate component and the optical component has a guiding pin configured to fix a position of the optical component with respect to the substrate component. One of the substrate component and the optical component not having the guiding pin has a guiding hole into which the guiding pin is inserted. The guiding hole is opened in a direction intersecting a direction in which the guiding pin is inserted into the guiding hole.

In this connector component, the substrate component is fixed to the substrate surface of the optical IC substrate, and the optical component is attached to and detached from the substrate component. The optical component is optically coupled with light incident on and emitted from the substrate surface of the optical IC substrate when attached to the substrate component. One of the substrate component and the optical component has a guiding pin, and one of the substrate component and the optical component not having the guiding pin has a guiding hole into which the guiding pin is inserted. The optical component is positioned with respect to the substrate component by inserting the guiding pin into the guiding hole. The guiding hole is opened in a direction intersecting the direction in which the guiding pin is inserted. Since the guiding hole is opened in the intersecting direction, even if a foreign substance enters the guiding hole, the foreign substance can be easily removed from the opened portion. The foreign substance that has entered the guiding hole can be reliably removed from the opened portion by cleaning. Thus, the foreign substance in the guiding hole can be removed more reliably and easily. Further, since the guiding hole has the opened portion, the substrate component can be downsized by the opened portion as compared with the case where the guiding hole is circular.

(2) In the above (1), the optical component may be attachable to and detachable from the substrate component in the direction intersecting the substrate surface. In this case, the optical component is moved in the intersecting direction with respect to the substrate component, and thus the optical component can be easily attached to and detached from the substrate component.

(3) In the above (1) or (2), the optical component may have a reflecting portion configured to reflect the light, which is emitted from the substrate surface in the direction intersecting the substrate surface, in a direction along the substrate surface. In this case, the reflecting portion reflects light to a direction along the substrate surface, and thus the height of the connector component with respect to the substrate surface is suppressed. Thus, the connector component can be made compact.

(4) In the above (1) or (2), the optical component may have a reflecting portion configured to reflect the light, which is incident in a direction along the substrate surface to the substrate surface. In this case, the reflecting portion reflects light from a direction along the substrate surface, and thus the height of the connector component with respect to the substrate surface is suppressed. Thus, the connector component can be made compact.

(5) In any one of the above (1) to (4), the connector component may include a coating layer applied to an inner surface of the guiding hole. In this case, the guiding pin can be inserted into the guiding hole more easily. The coating layer can be used as a buffer material for the guiding pin with respect to the guiding hole, and thus the guiding hole and the guiding pin can be prevented from being damaged. Further, since the coating layer is applied, the dirt is less likely to remain in the guiding hole, and thus the dirt can be more reliably prevented from remaining in the guiding hole.

(6) In any one of the above (1) to (5), the guiding hole may have a semicircular portion being semicircular when viewed along the direction intersecting the substrate surface. In this case, the shape of the guiding hole can be matched with the shape of the guiding pin, and thus, the guiding pin can be easily inserted into the guiding hole, and the positioning accuracy can be further enhanced.

(7) In any one of the above (1) to (6), the connector component may include a clip member configured to be hooked on the substrate component in a state of surrounding at least a portion of the optical component and the substrate component. In this case, the clip member surrounding at least a portion of the optical component and the substrate component is caught by the substrate component, and thus the substrate component and the optical component is prevented from coming off.

(8) In any one of the above (1) to (7), a material of the substrate component may be a transparent material. In this case, the substrate component is transparent, and thus light can pass through the substrate component itself. Thus, since it is possible to eliminate the need to form a hole or the like for passing light through the substrate component, it is possible to simplify the configuration of the substrate component.

(9) In any one of the above (1) to (8), the substrate component may have a first portion facing the substrate surface, and a second portion provided on a side opposite to the substrate surface when viewed from the first portion and having a length longer than a length of the first portion in a direction along the substrate surface. The clip member may be hooked on the second portion. In this case, the shape of the portion of the substrate component on which the clip member is hooked can be simplified. Thus, the configuration of the substrate component can be simplified.

### Details of Embodiment of the Present Disclosure

Specific examples of the connector component according to an embodiment of the present disclosure are described below with reference to the drawings. In the description of the drawings, the same or corresponding elements are denoted by the same reference signs, and redundant description will be omitted as appropriate. In the drawings, portions may be simplified or exaggerated for easy understanding, and the dimensional ratios and the like are not limited to the description of the drawings.

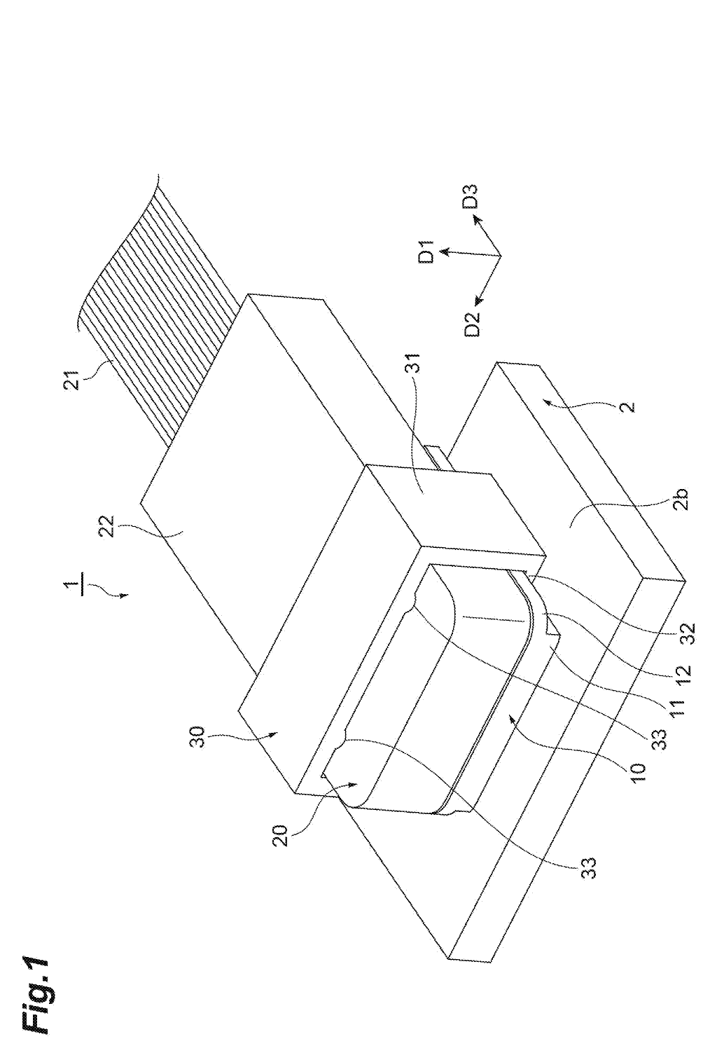

FIG. 1 is a perspective view showing a connector component 1 according to the embodiment. As shown in FIG. 1, the connector component 1 is disposed on a substrate surface 2b of an optical IC substrate 2. The connector component 1 includes a substrate component 10 fixed to the optical IC substrate 2, an optical component 20 configured to be attached to and detached from the substrate component 10, and a clip member 30 configured to be hooked on the substrate component 10 in a state of surrounding at least a portion of the optical component 20 and the substrate component 10.

In a state where the optical component 20 is attached to the substrate component 10, the optical IC substrate 2, the substrate component 10, and the optical component 20 are arranged in this order along a first direction D1. Light is incident on and emitted from the substrate surface 2b in the first direction D1 intersecting the substrate surface 2b. The first direction D1 is, for example, a direction orthogonal to the substrate surface 2b. Hereinafter, the first direction D1 may be referred to as up, upper side, or upward, and the direction opposite to the first direction D1 may be referred to as down, lower side, or downward. However, these directions are for convenience of description, and do not limit the arrangement position, orientation, or the like of an object.

The optical component 20 is, for example, an optical fiber component having a plurality of optical fibers 21. The optical fiber 21 is, for example, a single-mode fiber. However, the optical fiber 21 may be a multimode fiber or a polarization maintaining fiber, and the type of the optical fiber 21 is not particularly limited. The optical fibers 21 are arranged along a second direction D2 intersecting the first direction D1.

The optical component 20 includes, for example, the optical fiber 21 and a support member 22 that supports the optical fiber 21. The optical fiber 21 extends from the support member 22 in a third direction D3 that is a direction intersecting both the first direction D1 and the second direction D2. For example, the plurality of optical fibers 21 may be formed into a tape outside the support member 22. The arrangement interval (pitch) of the plurality of optical fibers 21 is, for example, 160 μm to 250 μm. The optical component 20 will be described in detail later.

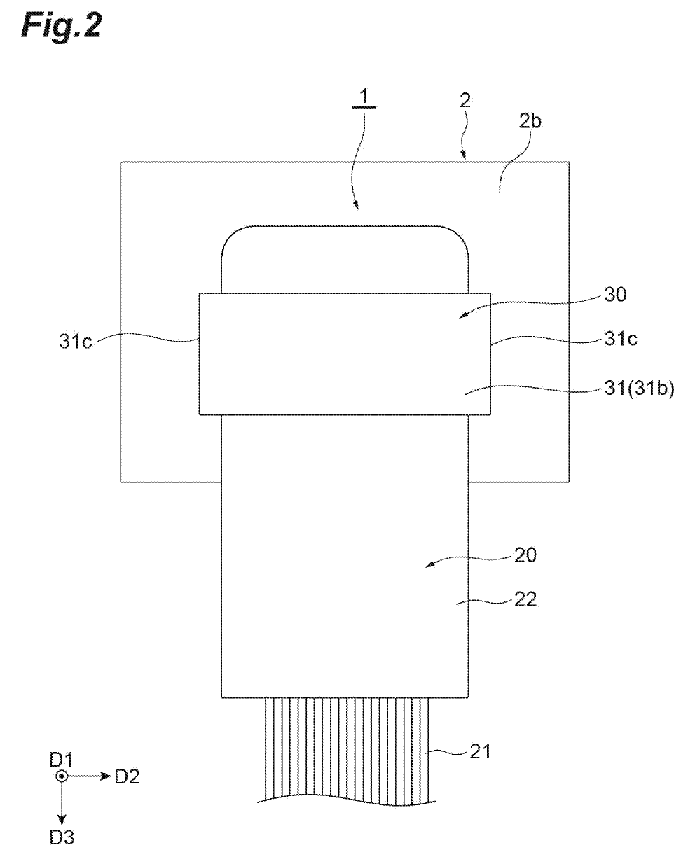

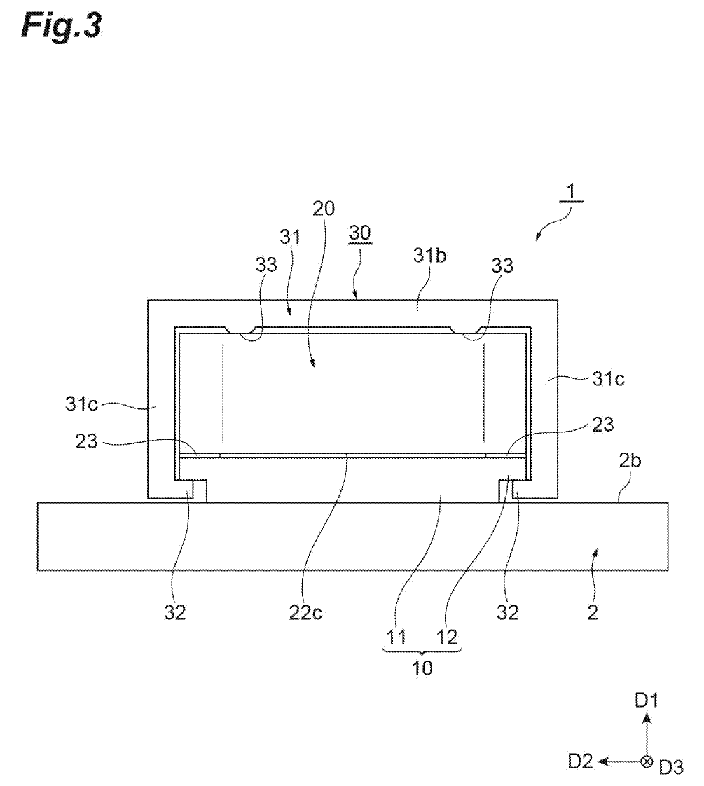

FIG. 2 is a plan view showing the connector component 1. FIG. 3 is a side view showing the connector component 1 as viewed along the third direction D3. The height of the connector component 1 (the length in the first direction D1) is, for example, 1 mm to 3 mm. As shown in FIGS. 2 and 3, the clip member 30 has, for example, a surrounding portion 31 configured to surround at least a portion of the optical component 20 and the substrate component 10, and a hook portion 32 that is a portion configured to be hooked on the substrate component 10.

The surrounding portion 31 includes a first plate-like portion 31b extending in the second direction D2 and the third direction D3 and having a thickness in the first direction D1, and a pair of second plate-like portions 31c extending downward from both ends of the second direction D2 of the first plate-like portion 31b, respectively. The second plate-like portion 31c extends in the first direction D1 and the third direction D3 and has a thickness in the second direction D2. The pair of second plate-like portions 31c are arranged along the second direction D2.

The hook portion 32 protrudes from an end portion of the surrounding portion 31 (each of the pair of second plate-like portions 31c) in a direction opposite to the first direction D1 along the second direction D2. When viewed along the direction opposite to the first direction D1 (in a plan view), a pair of hook portions 32 protrude in directions approaching each other. The pair of hook portions 32 enter the substrate component 10. Thus, the clip member 30 is prevented from coming off the substrate component 10.

The material of the clip member 30 is an elastic material. Thus, the clip member 30 can be attached to and detached from the substrate component 10. In a state where the clip member 30 is detached from the substrate component 10, the optical component 20 can be attached to and detached from the substrate component 10. For example, the material of the clip member 30 may be metal. However, the material of the clip member 30 may be resin.

The clip member 30 has a contact portion 33 that comes into contact with the optical component 20 when the clip member 30 is attached to the substrate component 10. The contact portion 33 protrudes downward from a surface of the first plate-like portion 31b facing downward. For example, the clip member 30 has a plurality of (two, as an example) contact portions 33. The plurality of contact portions 33 are arranged along, for example, the second direction D2. When the clip member 30 is attached to the substrate component 10, the contact portion 33 abuts against the optical component 20, so that the optical component 20 can be firmly fixed between the substrate component 10 and the clip member 30.

The substrate component 10 has a first portion 11 facing the substrate surface 2b and a second portion 12 provided on the opposite side of the substrate surface 2b when viewed from the first portion 11. The second portion 12 has a length in the direction along the substrate surface 2b (for example, the second direction D2) longer than the length of the first portion 11. The clip member 30 is hooked on the second portion 12. At this time, the hook portion 32 of the clip member 30 enters between the second portion 12 and the substrate surface 2b. Thus, the clip member 30 is prevented from coming off the substrate component 10.

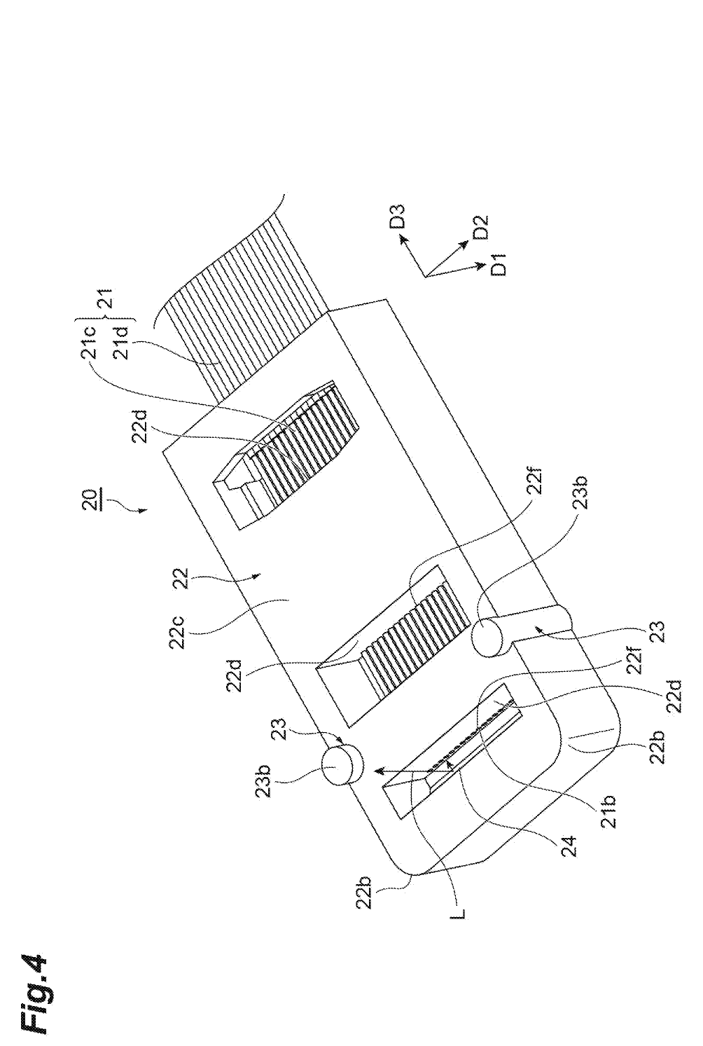

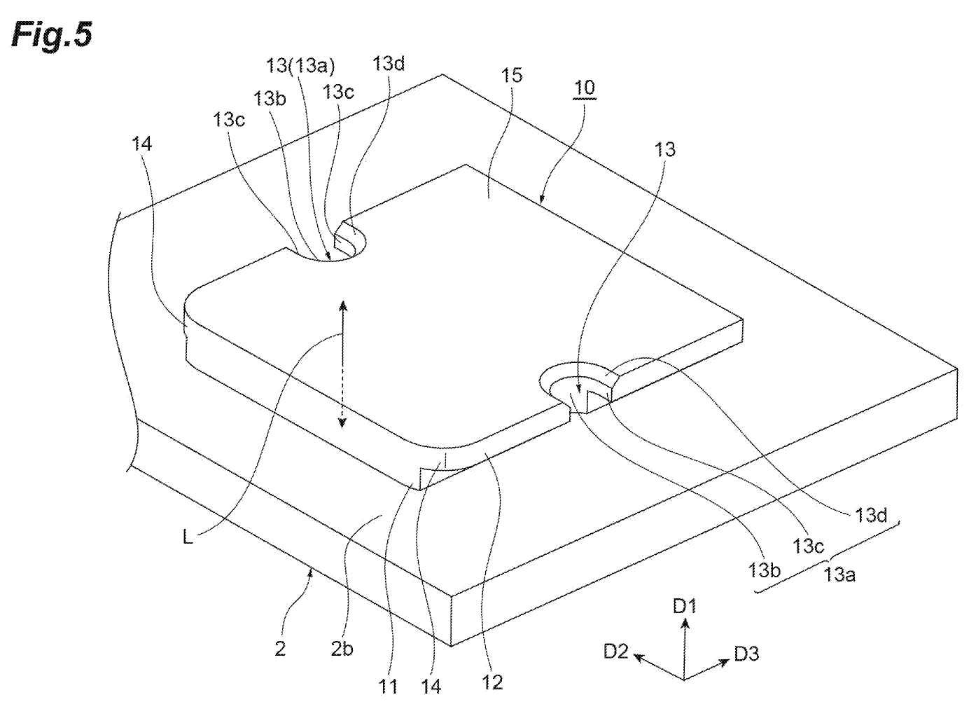

FIG. 4 is a perspective view showing the optical component 20. FIG. 5 is a perspective view showing the optical IC substrate 2 and the substrate component 10. As shown in FIGS. 3, 4 and 5, the optical component 20 has a guiding pin 23 configured to fix the position of the optical component 20 with respect to the substrate component 10, and the substrate component 10 has a guiding hole 13 into which the guiding pin 23 is inserted. The material of the substrate component 10 is a transparent material. As an example, the material of the substrate component 10 is glass. The optical IC substrate 2 is configured to allow light L to be incident on and emitted from the substrate surface 2b in a direction intersecting the substrate surface 2b. The light L that is incident on and emitted from the substrate surface 2b in a direction (first direction D1) intersecting the substrate surface 2b passes through the substrate component 10.

However, the material of the substrate component 10 may not be a transparent material. For example, solder reflow is performed on the optical IC substrate 2 to which the connector component 1 is fixed. The substrate component 10 may include a heat-resistant material that is resistant to the heat of solder reflow. The "heat of solder reflow" indicates heat applied to the substrate component during solder reflow. The term "resistant to heat" indicates that the material does not irreversibly deteriorate even when subjected to heat. The "deterioration" indicates, for example, deformation (deformation due to melting as an example). The "heat-resistant material" indicates a material that does not irreversibly deteriorate even when subjected to heat of solder reflow. Since the substrate component 10 contains the heat-resistant material, the warpage of the substrate component 10 can be reduced when solder reflow is performed. For example, the substrate component 10 may include at least one of borosilicate glass, Kovar, Invar, a liquid-crystal polymer, SUS304, and SUS430.

The optical component 20 is attachable to and detachable from the substrate component 10 in the first direction D1 which is a direction intersecting the substrate surface 2b. The optical component 20 is optically coupled with the light L when attached to the substrate component 10. The optical component 20 has a reflecting portion 24 configured to reflect the light L in a direction (third direction D3) along the substrate surface 2b. The optical component 20 reflects the light L from the optical fiber 21 toward the substrate surface 2b (in the direction opposite to the first direction D1).

The reflecting portion 24 reflects the light L incident on the substrate surface 2b in the first direction D1 intersecting the substrate surface 2b to the third direction D3 that is a direction along the substrate surface 2b. For example, the reflecting portion 24 is a concave mirror. For example, the light emitted from the optical fiber 21 is reflected toward the substrate surface 2b and converted into collimated light in the reflecting portion 24. The light L that is collimated light emitted from the substrate surface 2b is reflected toward the optical fiber 21 and is focused into the optical fiber 21 in the reflecting portion 24.

The support member 22 has, for example, a rectangular parallelepiped shape. For example, the support member 22 has a chamfered portion 22b positioned at an end portion of the support member 22 in a direction opposite to the third direction D3. The chamfered portion 22b is the R chamfered portion. The support member 22 has a pair of chamfered portions 22b, and the pair of chamfered portions 22b are arranged along the second direction D2. The material of the support member 22 is, for example, polyphenylene sulfide (PPS). However, the material of the support member 22 is not particularly limited.

The support member 22 has a facing surface 22c that is a surface facing the substrate component 10 along the first direction D1. The support member 22 has a recessed portion 22d recessed from the facing surface 22c. The support member 22 has, for example, a plurality of recessed portions 22d, and the plurality of recessed portions 22d are arranged along the third direction D3. The optical fiber 21 positioned in the support member 22 is visible from at least one of the plurality of recessed portions 22d. As an example, the support member 22 has three recessed portions 22d, and the optical fiber 21 is visible in two of the three recessed portions 22d. For example, an adhesive for fixing the optical fiber 21 to the support member 22 is supplied to the recessed portion 22d. Thus, it is possible to fix the plurality of optical fibers 21 to the support member 22.

The support member 22 has an optical fiber holding hole 22f through which the optical fiber 21 passes. The support member 22 has a plurality of optical fiber holding holes 22f, and the optical fibers 21 are inserted into the plurality of optical fiber holding holes 22f. The plurality of optical fiber holding holes 22f are arranged along the second direction D2. The optical fiber holding hole 22f extends along the third direction D3 between the two recessed portions 22d arranged along the third direction D3. For example, two optical fiber holding holes 22f are arranged along the third direction D3.

The optical fiber 21 includes an optical fiber core wire 21c and a covering layer 21d covering the optical fiber core wire 21c. The optical fiber core wire 21c is, for example, a glass fiber. The covering layer 21d is removed from the end portion of the optical fiber 21, and the portion of the optical fiber 21 from which the covering layer 21d is removed (the optical fiber core wire 21c) is inserted and held in the optical fiber holding hole 22f. The outer diameter (diameter) of the optical fiber core wire 21c is, for example, 80 μm to 125 μm. The outer diameter (diameter) of the covering layer 21d is, for example, 160 μm to 250 μm.

The reflecting portion 24 is provided in the recessed portion 22d close to the end portion of the support member 22 in a direction opposite to the third direction D3 among the plurality of recessed portions 22d. The optical fiber holding hole 22f is opened in the recessed portion 22d where the reflecting portion 24 is provided, and a tip end surface 21b of the optical fiber 21 is exposed from the opening. The tip end surface 21b faces the reflecting portion 24 along the third direction D3, and the light L reflected from the reflecting portion 24 is incident on and emitted from the tip end surface 21b.

For example, the guiding pin 23 is integrally formed with the support member 22. However, the guiding pin 23 may be configured separately from the support member 22. That is, the guiding pin 23 may be a separate component from the support member 22. In this case, the material of the guiding pin 23 may be the same as the material of the support member 22, or may be different from the material of the support member 22.

The material of the guiding pin 23 may be metal or ceramic. In this case, the material of the guiding pin 23 may be SUS (Steel Use Stainless), a cemented carbide material, or zirconia. The material of the guiding pin 23 may be the same as the material of the substrate component 10 described above. In a case where the guiding pin 23 is a separate component from the support member 22, the guiding pin 23 may be attached to the support member 22 by bonding. Alternatively, the guiding pin 23 may be attached to the support member 22 by press-fitting. In this case, the support member 22 may have a recessed portion having an arc shape when viewed along the first direction D1, and the guiding pin 23 may be press-fitted into the recessed portion.

The guiding pin 23 extends along the first direction D1. The optical component 20 has a plurality of (e.g., two) guiding pins 23, and the plurality of guiding pins 23 are arranged along the second direction D2. The guiding pin 23 is, for example, cylindrical. The outer diameter of the guiding pin 23 is, for example, 0.55 mm to 0.7 mm. The guiding pin 23 has a protruding portion 23b protruding from the facing surface 22c of the support member 22, and the protruding portion 23b is inserted into the guiding hole 13. The protruding portion 23b protrudes from the support member 22 in a direction opposite to the first direction D1. The height of the protruding portion 23b with respect to the facing surface 22c is 0.2 mm, for example.

For example, when the guiding pin 23 is inserted into the guiding hole 13, the protruding portion 23b does not penetrate the substrate component 10. In this case, the lower end of the protruding portion 23b is positioned above the hook portion 32 of the clip member 30. When the guiding pin 23 is inserted into the guiding hole 13, the protruding portion 23b is separated from the substrate surface 2b. The length from the substrate surface 2b to the guiding pin 23 (the protruding portion 23b) when the guiding pin 23 is inserted into the guiding hole 13 is, for example, 0.1 mm to 0.2 mm.

The substrate component 10 has, for example, a plate shape extending in the second direction D2 and the third direction D3 and having a thickness in the first direction D1. As an example, the substrate component 10 has a chamfered portion 14 positioned at the end portion of the substrate component 10 in a direction opposite to the third direction D3. The chamfered portion 14 is the R chamfered portion. The substrate component 10 has a pair of chamfered portions 14, and the pair of chamfered portions 14 are arranged along the second direction D2.

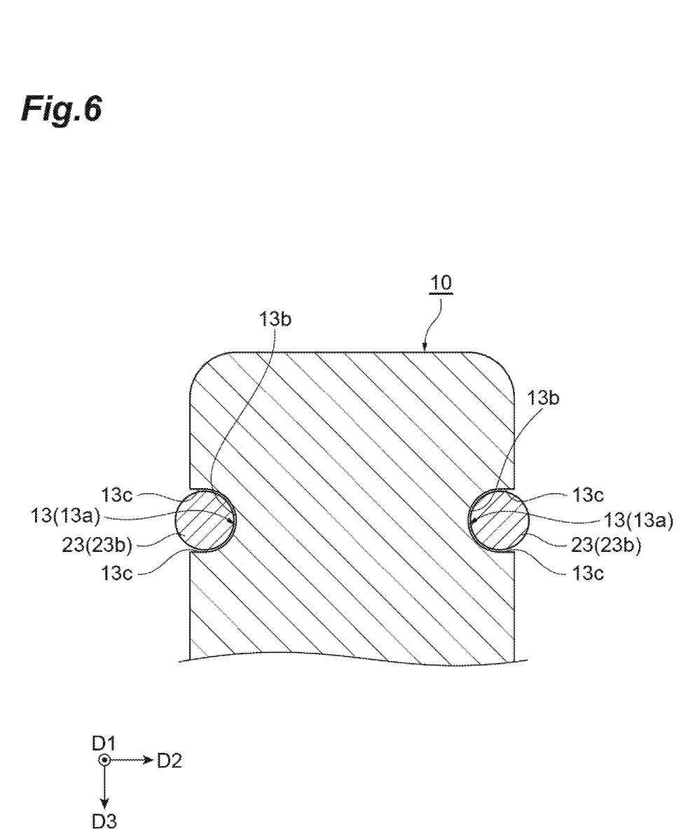

FIG. 6 is a cross-sectional view showing a state in which the guiding pin 23 is inserted into the guiding hole 13. As shown in FIGS. 5 and 6, the guiding hole 13 is opened in a direction intersecting with a direction in which the guiding pin 23 is inserted into the guiding hole 13. In the embodiment, the guiding pin 23 is inserted into the guiding hole 13 along the first direction D1, and the guiding hole 13 is opened in the second direction D2 intersecting the first direction D1.

For example, the guiding hole 13 is formed by an inner surface 13a recessed in the substrate component 10. The inner surface 13a includes a semicircular portion 13b that is semicircular when viewed along the first direction D1 intersecting the substrate surface 2b, and a pair of linear portions 13c that extend from an end portion of the semicircular portion 13b to the second direction D2 when viewed along the first direction D1. The semicircular portion 13b has an inner diameter (diameter) of, for example, 0.55 mm to 0.7 mm. The pair of linear portions 13c are arranged along the third direction D3. For example, the semicircular portion 13b is formed in the first portion 11 and the second portion 12, and the linear portion 13c is formed only in the second portion 12.

By having the linear portion 13c, the guiding pin 23 enters deeply the guiding hole 13 as compared with the case where the linear portion 13c is not provided. However, the guiding hole 13 does not have to include the linear portion 13c. That is, the guiding hole 13 may include only the semicircular portion 13b. In this case, the length in the second direction D2 of the substrate component 10 can be reduced, and thus reducing the length contributes to further making the substrate component 10 compact.

The substrate component 10 has a facing surface 15 facing the optical component 20. The facing surface 15 extends in both the second direction D2 and the third direction D3 at the end portion of the first direction D1 of the substrate component 10. The inner surface 13a of the guiding hole 13 may include, for example, a tapered surface 13d extending obliquely downward from the facing surface 15. The tapered surface 13d is positioned outside the semicircular portion 13b when viewed from above, and extends along the outer periphery of the semicircular portion 13b. The tapered surface 13d is formed around the semicircular portion 13b when viewed along the first direction D1. Thus, the guiding pin 23 can be inserted into the guiding hole 13 more smoothly.

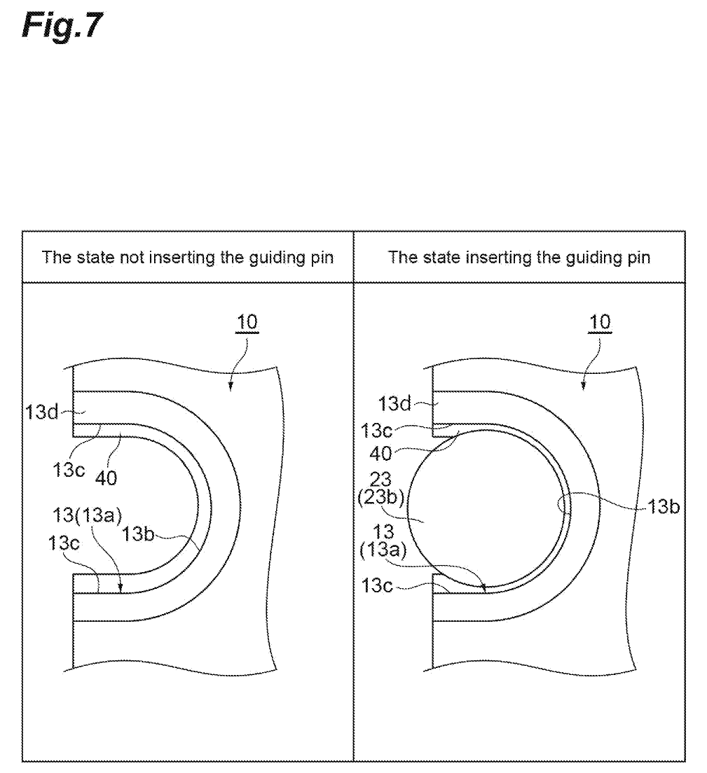

As shown in FIG. 7, the connector component 1 has a coating layer 40 applied to the inner surface 13a of the guiding hole 13. In the embodiment, the substrate component 10 has the coating layer 40. The coating layer 40 is provided, for example, to facilitate insertion of the guiding pin 23 into the guiding hole 13 and to prevent the substrate component 10 from being cracked when the guiding pin 23 is inserted into the guiding hole 13. The coating layer 40 is a buffer material when the guiding pin 23 is inserted into the guiding hole 13. The coating layer 40 is provided in the guiding hole 13, and thus, it is possible to prevent the substrate component 10 from being cracked due to the insertion of the guiding pin 23.

The material of the coating layer 40 includes, for example, at least one of polysilazane, siloxane, fluororesin, and a ceramic material. For example, the material of the coating layer 40 may include a fluororesin. In this case, a frictional force that may occur when the guiding pin 23 is inserted into the guiding hole 13 can be reduced. The material of the coating layer 40 may include a heat-resistant material that is resistant to the heat of solder reflow, similarly to the material of the substrate component 10. The material of the coating layer 40 may include a material having a water repellent effect. The material of the coating layer 40 is softer than the material of the guiding pin 23.

For example, the clearance from the inner surface 13a of the guiding hole 13 to the outer peripheral surface of the guiding pin 23 in a state where the guiding pin 23 is inserted into the guiding hole 13 is 1 μm to 2 μm. In addition, the thickness of the coating layer 40 may be, for example, 5 μm. When the coating layer 40 has a certain thickness, the clearance can be increased by reducing the outer diameter of the guiding pin 23 with respect to the inner diameter of the guiding hole 13.

That is, the coating layer 40 is provided in the guiding hole 13, so that when the guiding pin 23 is inserted into the guiding hole 13, the guiding pin 23 pushes the coating layer 40 to spread toward the inner surface 13a of the guiding hole 13. Thus, since the error of the position of the guiding pin 23 that may be caused by the large inner diameter of the guiding hole 13 can be reduced, the reproducibility of the attaching position of the guiding pin 23 with respect to the guiding hole 13 is improved, and as a result, the loss of the optical coupling of the light L can be reduced.

The coating layer 40 may be formed in the guiding hole 13 by, for example, immersion. In this case, the coating layer 40 is formed on the entire substrate component 10 as well as the guiding hole 13. However, the coating layer 40 may be formed only in the guiding hole 13 by masking. In addition, the coating layer 40 may be applied to the guiding hole 13 by spraying. As described above, the method of forming the coating layer 40 on the guiding hole 13 can be changed as appropriate.

Incidentally, for example, in the assembly step of the connector component 1, it may be required that no foreign substance remains on the substrate component 10. In the optical connection in the connector component 1, the reproducibility of the position in a case where the optical component 20 is repeatedly attached to and detached from the substrate component 10 may be required. When a foreign substance having a size of about several micrometers adheres to the guiding hole 13, it may affect the optical connection, and thus, it is required to reliably remove such a foreign substance. When flux residue remains in the guiding hole 13 in the reflow step, it may cause a malfunction or a contact failure, and thus it may be necessary to remove the flux residue by performing a cleaning step using a cleaning liquid.

In the cleaning step, at least one of removal of a foreign substance by a cleaning swab, immersion of the substrate component 10 in a cleaning liquid, and removal of a foreign substance by spraying is performed. In the cleaning for removing the flux residue, at least one of a spray (shower) cleaning method, a submerged jet (jet cleaning) method, and an ultrasonic cleaning method is adopted. The cleaning liquid is, for example, an aqueous cleaning agent or a solvent-based cleaning agent. The solvent-based cleaning agent is a hydrocarbon-based cleaning agent, a chlorine-based cleaning agent, a fluorine-based cleaning agent, a bromine-based cleaning agent, or an alcohol-based cleaning agent.

It may be necessary to clean the connector component using the various cleaning methods and cleaning agents described above to reliably remove a foreign substance from the connector component. However, in a case where the guiding hole into which the guiding pin is inserted is a circular hole, it may be difficult to remove a foreign substance that has entered the circular hole, and there is a concern that the optical connection may be affected or a contact failure may occur. In contrast, the connector component 1 according to the embodiment can solve the above concern. Hereinafter, effects obtained from the connector component 1 according to the embodiment will be described.

In the connector component 1, the substrate component 10 is fixed to the substrate surface 2b of the optical IC substrate 2, and the optical component 20 is attached to and detached from the substrate component 10. The optical component 20 is optically coupled with the light L incident on and emitted from the substrate surface 2b of the optical IC substrate 2 when attached to the substrate component 10. The optical component 20 has the guiding pin 23, and the substrate component 10 has the guiding hole 13 into which the guiding pin 23 is inserted. The optical component 20 is positioned with respect to the substrate component 10 by inserting the guiding pin 23 into the guiding hole 13. The guiding hole 13 is opened in a direction (for example, the second direction D2) intersecting the direction in which the guiding pin 23 is inserted. Since the guiding hole 13 is opened in the intersecting direction, even if a foreign substance enters the guiding hole 13, the foreign substance can be easily removed from the opened portion.

The foreign substance entering the guiding hole 13 can be reliably removed from the opened portion by cleaning. Thus, the foreign substance in the guiding hole 13 can be removed more reliably and easily. Further, since the guiding hole 13 has the opened portion, the length in the second direction D2 of the substrate component 10 is reduced by the opened portion as compared with the case where the guiding hole is circular, and the substrate component 10 can be downsized. Further, since the guiding hole 13 has the opened portion, the coating layer 40 can be easily applied to the guiding hole 13.

The optical component 20 may be attachable to and detachable from the substrate component 10 in a direction intersecting the substrate surface 2b. In this case, the optical component 20 can be easily attached to and detached from the substrate component 10 by moving the optical component 20 in the intersecting directions (for example, upward and downward) with respect to the substrate component 10.

The optical component 20 may include the reflecting portion 24 configured to reflect the light L emitted from the substrate surface 2b in a direction intersecting the substrate surface 2b in a direction along the substrate surface 2b. In this case, the reflecting portion 24 reflects the light L in the direction along the substrate surface 2b, so that the height of the connector component 1 with respect to the substrate surface 2b can be reduced to be 3 mm or less. Thus, the connector component 1 can be made compact.

The connector component 1 may have the coating layer 40 applied to the inner surface of the guiding hole 13. In this case, the guiding pin 23 can be more easily inserted into the guiding hole 13. The coating layer 40 can be used as a buffer material for the guiding pin 23 with respect to the guiding hole 13, and thus can prevent the guiding hole 13 and the guiding pin 23 from being damaged. Furthermore, since the coating layer 40 is applied, dirt is less likely to remain in the guiding hole 13, and thus the dirt can be more reliably prevented from remaining in the guiding hole 13.

The guiding hole 13 may have the semicircular portion 13b that is semicircular when viewed along a direction intersecting the substrate surface 2b. In this case, since the shape of the guiding hole 13 can be matched with the shape of the guiding pin 23, the guiding pin 23 can be easily inserted into the guiding hole 13, and the positioning accuracy can be further improved.

The connector component 1 may include the clip member 30 configured to be hooked on the substrate component 10 in a state of surrounding at least a portion of the optical component 20 and the substrate component 10. In this case, the clip member 30 surrounding at least a portion of the optical component 20 and the substrate component 10 is hooked on the substrate component 10, and thus the substrate component 10 and the optical component 20 is prevented from coming off.

The material of the substrate component 10 may be a transparent material. In this case, the substrate component 10 is transparent, and thus the light L can pass through the substrate component 10 itself. Thus, since it is possible to eliminate the need to form a hole or the like for passing the light L through the substrate component 10, it is possible to further simplify the configuration of the substrate component 10.

The substrate component 10 may include the first portion 11 facing the substrate surface 2b, and the second portion 12 provided on the side opposite to the substrate surface 2b when viewed from the first portion 11 and having a length longer than the length of the first portion 11 in a direction (for example, the second direction D2) along the substrate surface 2b, and the clip member 30 may be hooked on the second portion 12. In this case, the shape of the portion of the substrate component 10 on which the clip member 30 is hooked can be simplified. Thus, the configuration of the substrate component 10 can be simplified.

The embodiment of the connector component according to the present disclosure has been described above. However, the connector component according to the present disclosure is not limited to the contents of the above-described embodiment, and may be modified within the scope of the gist described in the claims. That is, the shape, size, material, number, and arrangement of each part of the connector component according to the present disclosure can be appropriately changed within the scope of the above gist.

For example, in the above-described embodiment, the guiding hole 13 having the semicircular portion 13b has been described. However, the shape of the guiding hole may be changed as appropriate as long as the guiding hole is opened in a direction intersecting the direction in which the guiding pin is inserted into the guiding hole. The shape of the guiding hole may be, for example, a V-shape, a rectangular shape, or a parabolic shape.

In the above-described embodiment, an example in which the optical component 20 is attachable to and detachable from the substrate component 10 in the first direction D1 that is a direction intersecting the substrate surface 2b has been described. However, the optical component may be attachable to and detachable from the substrate component in a direction parallel to the substrate surface (for example, the third direction D3). As described above, the direction of attachment and detachment of the optical component to and from the substrate component is not particularly limited.

In the above-described embodiment, the optical component 20 having the reflecting portion 24 configured to reflect the light L in the direction along the substrate surface 2b has been described. However, the connector component may include an optical component that does not have the reflecting portion 24, instead of the optical component 20. In this case, for example, the optical component is an optical component such that the plurality of optical fibers 21 extend from the support member 22 along the first direction D1.

In the above-described embodiment, the connector component 1 including the substrate component 10 having the guiding hole 13 and the optical component 20 having the guiding pin 23 has been described. However, in the connector component, it is sufficient that one of the substrate component and the optical component has a guiding pin, and one of the substrate component and the optical component not having a guiding pin has a guiding hole. That is, the substrate component may have a guiding pin, and the optical component may have a guiding hole. Further, the optical component may have a coating layer instead of the substrate component.

What is claimed is:

1. A connector component comprising:
a substrate component fixed to an optical IC substrate configured to allow light to be incident on and emitted from a substrate surface in a direction intersecting the substrate surface; and
an optical component configured to be attached to and detached from the substrate component and optically coupled with the light when attached to the substrate component,
wherein one of the substrate component and the optical component has a guiding pin configured to fix a position of the optical component with respect to the substrate component,
wherein one of the substrate component and the optical component not having the guiding pin has a guiding hole into which the guiding pin is inserted, and
wherein the guiding hole is opened in a direction intersecting a direction in which the guiding pin is inserted into the guiding hole.

2. The connector component according to claim 1, wherein the optical component is attachable to and detachable from the substrate component in the direction intersecting the substrate surface.

3. The connector component according to claim 1, wherein the optical component has a reflecting portion configured to reflect the light, which is emitted from the substrate surface in the direction intersecting the substrate surface, in a direction along the substrate surface.

4. The connector component according to claim 1, wherein the optical component has a reflecting portion configured to reflect the light, which is incident in a direction along the substrate surface to the substrate surface.

5. The connector component according to claim 1, comprising a coating layer applied to an inner surface of the guiding hole.

6. The connector component according to claim 1, wherein the guiding hole has a semicircular portion being semicircular when viewed along the direction intersecting the substrate surface.

7. The connector component according to claim 1, comprising a clip member configured to be hooked on the substrate component in a state of surrounding at least a portion of the optical component and the substrate component.

8. The connector component according to claim 1, wherein a material of the substrate component is a transparent material.

9. The connector component according to claim 7,
wherein the substrate component has a first portion facing the substrate surface, and a second portion provided on a side opposite to the substrate surface when viewed from the first portion and having a length longer than a length of the first portion in a direction along the substrate surface, and
wherein the clip member is hooked on the second portion.
